(19) United States
(12) Patent Application Publication
(10) Pub. No.: US 2008/0042788 A1
(43) Pub. Date: Feb. 21, 2008

(54) Electromagnetic switch provided with a packing capable of suppressing wobbling motions of an electromagnetic coil

(75) Inventors: Tadahiro Kurasawa, Chita-gun (JP); Kazuhiro Andoh, Okazaki-shi (JP); Yamato Utsunomiya, Kariya-shi (JP)

Correspondence Address: OLIFF & BERRIDGE, PLC, P.O. BOX 320850, ALEXANDRIA, VA, 22320-4850, US

(73) Assignee: DENSO CORPORATION, KARIYA- CITY (JP)

(21) Appl. No.: 11/819,445

(22) Filed: Jun. 27, 2007

(30) Foreign Application Priority Data
Jul. 7, 2006 (JP) 2006-188102

(51) Int. Cl. H01H 9/02

(52) U.S. Cl. 335/202

(57) ABSTRACT

An electromagnetic switch is provided, which includes a solenoid, a housing member and a sealing member. The solenoid includes an electromagnetic coil which produces an electromagnetic force upon supply of current thereto and a case accommodating the solenoid. The housing member accommodates a pair of contacts of the switch, and is caulked and secured to the case through the sealing member. The sealing member has elasticity and prevents wobbling motions of the electromagnetic coil by the elasticity.

### CROSS-REFERENCE TO RELATED APPLICATION

This application is based on and claims the benefit of priority from earlier Japanese Patent Application No. 2006-188102 filed Jul. 7, 2006, the description of which is incorporated herein by reference.

### BACKGROUND OF THE INVENTION

1. Technical Field of the Invention

The present invention relates to an electromagnetic switch and, in particular, to an electromagnetic switch for opening/closing an electrical contact provided in a motor circuit, such as of a starter.

2. Related Art

A starter for starting an engine is generally provided with an electromagnetic switch for opening/closing a main contact of the motor circuit. The electromagnetic switch includes a solenoid for attracting a plunger with an attraction force of an electromagnet to drive a movable contact, and a contact cover provided with a pair of contacts which are fixed thereto by molding for connection to the motor circuit.

The movable contact driven by the solenoid is brought into contact with the pair of fixed contacts to close the main contact. The solenoid has an electromagnetic coil which is accommodated in a switch case that forms a magnetic circuit. A stationary core disposed at one end of the electromagnetic coil is assembled into the switch case by being press-fitted and fixed to an inner periphery of the switch case. A grounding end portion of the electromagnetic coil is joined to an end face of the stationary core by welding, for example.

The electromagnetic switch configured as mentioned above may form a gap between a bobbin of the electromagnetic coil and a bottom face of the switch case or between the bobbin and the stationary core due to their dimensional tolerances caused at the time of manufacturing the components. When the starter receives vibration from the engine, the formation of such a gap may cause relative wobbling motions between the electromagnetic coil and the stationary core. As a result, the grounding end portion of the electromagnetic coil joined to the stationary core can be disconnected.

As a measure for such disconnection, Japanese Patent Laid-Open No. 5-126018 discloses an electromagnetic switch which can prevent the electromagnetic coil from vibrating by inserting an elastic body, such as a leaf spring, between the bottom face of the switch case and the bobbin. Further, Japanese Patent Laid-Open No. 5-205594 discloses an electromagnetic switch which can prevent the electromagnetic coil from wobbling motions by providing a projection at a bobbin made of resin and utilizing the elasticity of the projection.

However, the configuration disclosed in Japanese Patent Laid-Open No. 5-126018 requires ensuring a space for locating the elastic body, which space may be larger than the gap actually formed between the bobbin and the bottom face of the switch case or between the bobbin and the stationary core. Further, the addition of a component (the elastic body) has prevented the reduction in the size and cost of the electromagnetic switch. On the other hand, the technique disclosed in Japanese Patent Laid-Open No. 5-205594, that is, a technique for preventing the electromagnetic coil from vibrating by utilizing the elasticity of the resin member, may cause creeping of the resin bobbin when the electromagnetic switch is exposed to a high-temperature atmosphere, leading to a problem of not exerting a function of preventing the wobbling motions of the electromagnetic coil.

### SUMMARY OF THE INVENTION

The present invention has been made in light of the problems of the conventional art as mentioned above, and has as its object to provide an electromagnetic switch which can resolve these problems. In particular, the present invention has an object of providing an electromagnetic switch which can prevent wobbling motions of an electromagnetic coil and can reduce the size of the electromagnetic switch.

The present invention provides an electromagnetic switch including a solenoid, a housing member and a sealing member.

The solenoid includes an electromagnetic coil unit generating an electromagnetic force by supplied an electric power thereto. The housing member accommodates a pair of contacts. One of the pair of contacts is subjected to selectively connect to and disconnect from the other by the electromagnetic force, whereby the switch is switched on/off. The sealing member has elasticity, seals a linking portion between the solenoid and the housing member and suppresses wobbling motions of the unit.

### BRIEF DESCRIPTION OF THE DRAWINGS

In the accompanying drawings:

FIG. 1 is a cross sectional view of an electromagnetic switch according to an embodiment of the present invention;

FIG. 2A is an enlarged view of a part II circled with a broken line in FIG. 1;

FIG. 2B illustrates a first modification of the part II illustrated in FIG. 2A;

FIG. 2C illustrates a second modification of the part II illustrated in FIG. 2A;

FIG. 2D illustrates a third modification of the part II illustrated in FIG. 2A;

FIG. 2E illustrates a fourth modification of the part II illustrated in FIG. 2A;

FIG. 2F illustrates a fifth modification of the part II illustrated in FIG. 2A;

FIG. 3A is an illustration of a disc part of a stationary core and a packing according to the embodiment, as viewed from the right side of FIG. 1;

FIG. 3B is an illustration of f a disc part of a stationary core and a packing according to the first modification, as viewed from the right side of FIG. 1;

FIG. 3C is an illustration of a disc part of a stationary core, a packing and a caulked part of a contact cover according to the second modification, as viewed from the right side of FIG. 1;

FIG. 3D is an illustration of a base part of a stationary core and a packing according to the third modification, as viewed from the right side of FIG. 1; and

FIG. 4 is a diagram explaining an origin of wobbling motions of an electromagnetic coil enlarged by using a view of a part IV illustrated in FIG. 1.

### DETAILED DESCRIPTION OF THE PREFERRED EMBODIMENT

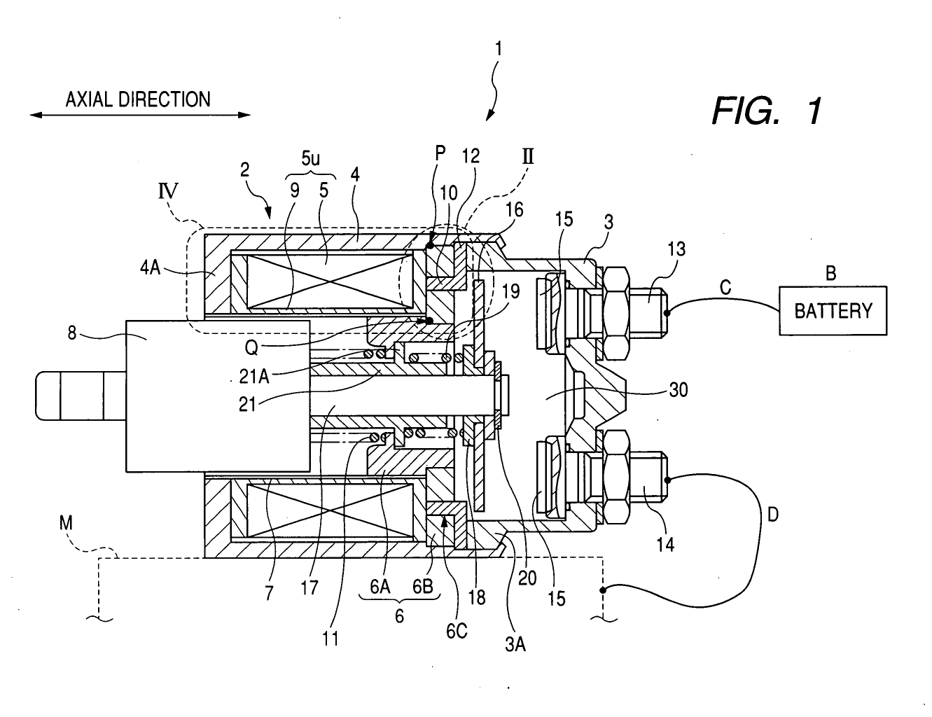

Hereinafter is described in detail an embodiment of the present invention with reference to FIGS. 1, 2A and 3A.

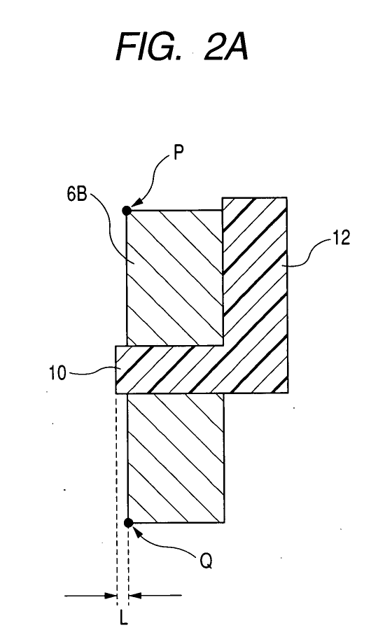

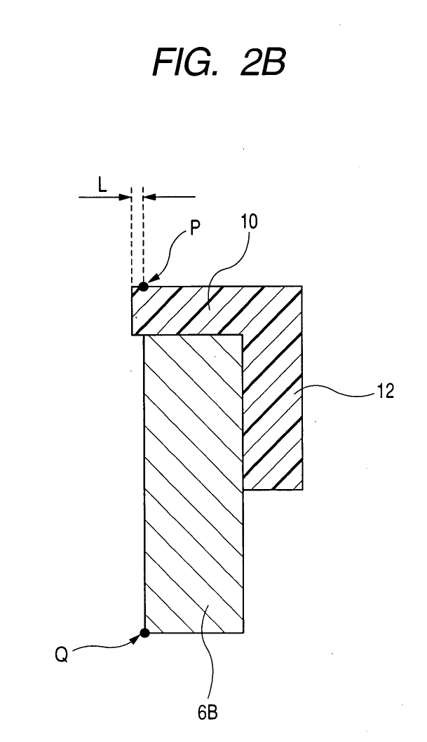

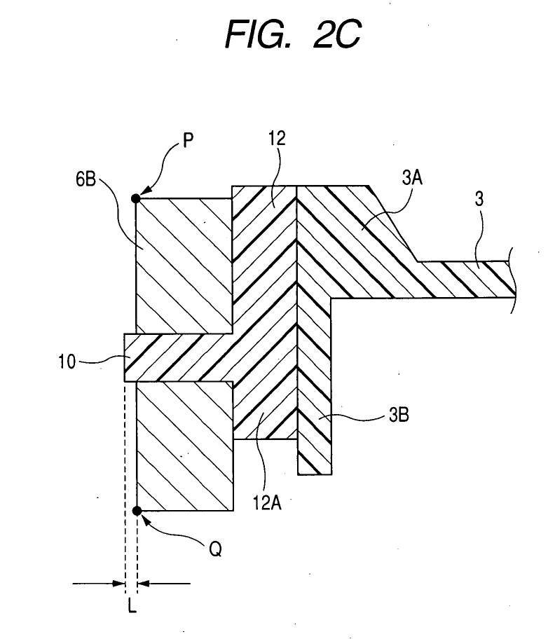

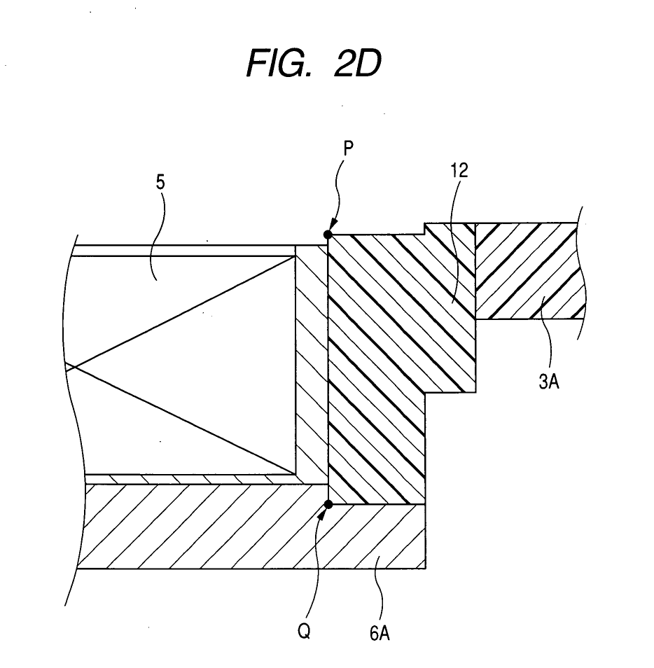

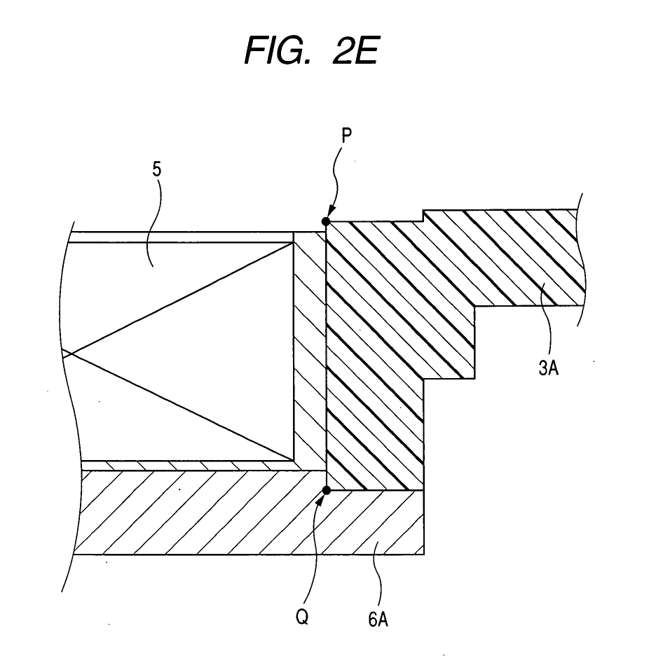

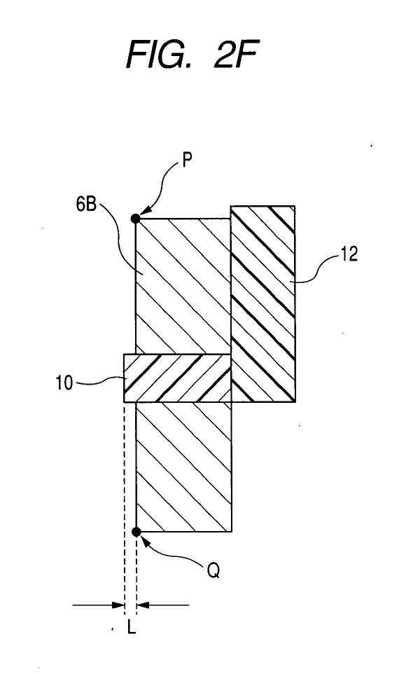

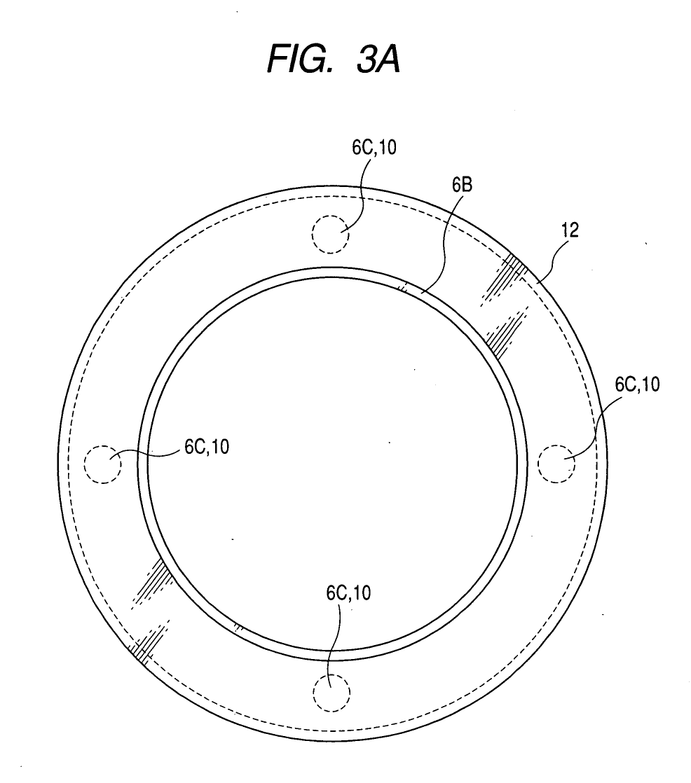

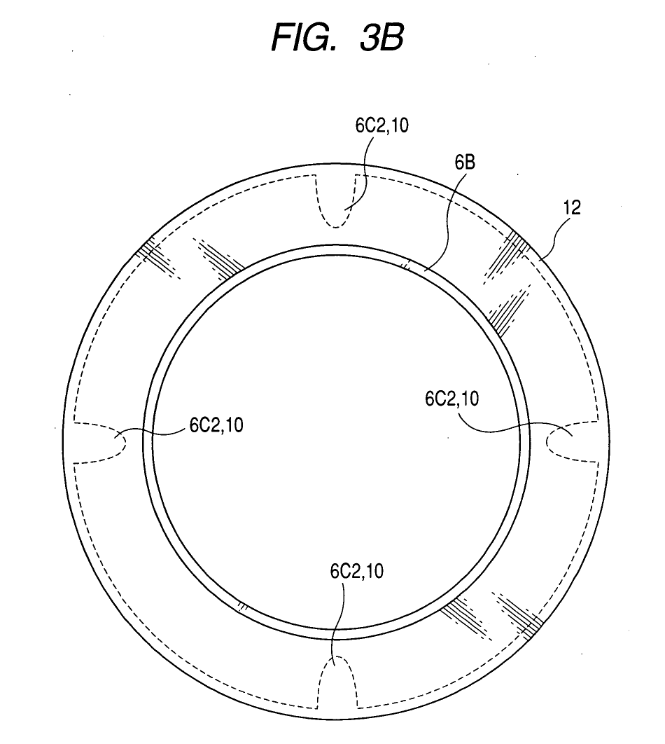

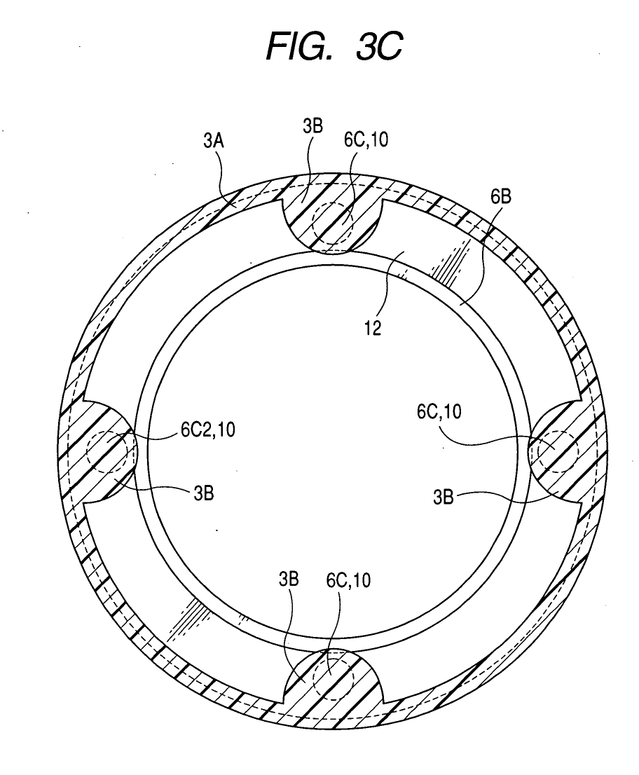

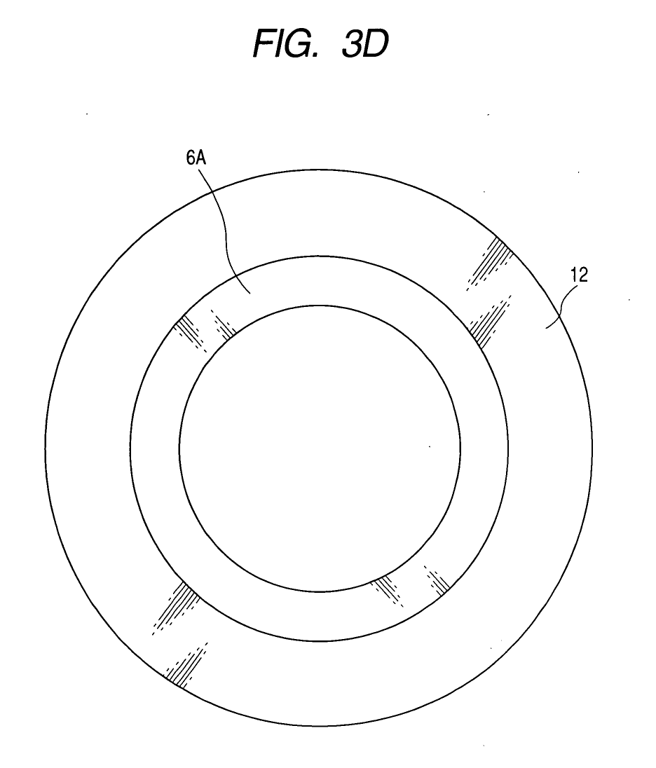

FIG. 1 is a cross sectional view of an electromagnetic switch 1 according to the present embodiment. FIG. 2A is an enlarged view of a part II circled with a broken line in FIG. 1, or of a principal part of the present invention. FIG. 3A is an illustration of a disc part 6B of a stationary core 6 and a packing 12, as viewed from the right side of FIG. 1.

### Embodiment

The electromagnetic switch 1 of the present embodiment has a function of opening/closing a main contact (which will be described later) provided at a motor circuit of a starter (only a portion the starter proximate to the electromagnetic switch 1 is shown in FIG. 1). As shown in FIG. 1, the electromagnetic switch 1 includes a solenoid 2 forming an electromagnet, and a contact cover 3 (recited as a housing member in the appended claims) accommodating the main contact. The electromagnetic switch 1 is typically mounted on a starter motor M and directly receives vibration of the starter motor M.

The solenoid 2 includes a switch case 4 forming a yoke, an electromagnetic coil 5 accommodated in the switch case 4, the stationary core 6 to be magnetized with the supply of current to the electromagnetic coil 5, and a plunger 8 slidably inserted along an inner periphery of the electromagnetic coil 5 through a sleeve 7.

The electromagnetic coil 5 includes an attraction coil that produces magnetic force to attract the plunger 8, and a holding coil that produces magnetic force for holding the attracted plunger 8. Double layer winding is provided to the electromagnetic coil 5 in a bobbin 9 made of resin. The electromagnetic coil 5 and the bobbin 9 constitute an electromagnetic coil unit 5U. The electromagnetic coil unit 5U, resultantly the electromagnetic coil 5 is suppressed from wobbling motions mainly in the axial direction of the electromagnetic switch 1 (leftward and rightward directions in FIG. 1) by a vibration-absorbing member 10 which will be described later.

The stationary core 6 includes a base part 6A facing the plunger 8, and a disc part 6B which is arranged at one axial end of the electromagnetic coil 5. An outer peripheral corner of the disc part 6B is brought into contact with a stepped portion provided at an opening-side inner periphery of the switch case 4, to determine the position of the stationary core 6. Although the stationary core 6 of the present embodiment is divided into the base part 6A and the disc part 6B, both of the parts may be integrated into a single body.

The plunger 8 is arranged along the inner periphery of the electromagnetic coil 5 so as to be opposed to the base part 6A of the stationary core 6, while being biased in a direction drawn apart from the base part 6A (leftward direction in FIG. 1) by a return spring 11 arranged between the plunger 8 and the base part 6A.

The contact cover 3 is made of resin and is secured to the solenoid 2 through a rubber packing 12 (the inventive sealing member). In particular, the contact cover 3 is assembled with the packing 12 being interposed between itself and the disc part 6B of the stationary core 6, and caulked and secured to an end portion of the switch case 4. Thus, the contact cover is linked up with the solenoid 2. The packing 12 (and the vibration-absorbing member 10 integrated into the packing 12) may alternatively be made of a material other than rubber, such as a high polymer material having elasticity (e.g., elastomer). The interior of the contact cover 3 serves as a contact chamber 30 for accommodating the main contact.

The main contact is formed by a pair of fixed contact 15 and a movable contact 16. The pair of fixed contacts 15 are connected to the motor circuit through two external terminals 13 and 14, and the movable contact 16 is connected to or disconnected from the pair of the fixed contacts 15. The two external terminals 13 and 14 in particular are a B terminal 13 which is connected to an on-vehicle battery B through a battery cable C, and an M terminal 14 which is connected to a lead D drawn out from the starter motor M. These external terminals 13 and 14 are molded to the contact cover 3 for fixation. The electromagnetic switch 1 is obliged to receive vibration from the starter motor M through the M terminal 14 and the lead D.

The pair of the fixed contacts 15 are each integrated to the external terminals 13 and 14 and are arranged in the contact chamber 30 being opposed to the movable contact 16.

The movable contact 16 slidably provided at an end portion of a shaft 17 through an insulation member 18, the shaft 17 being fixed to the plunger 8. The movable contact 16 is biased toward a tip end portion of the shaft 17 (rightward direction in FIG. 1) by a contact-pressure spring 19, while being in contact with a washer 20 fixed at the tip end portion of the shaft 17 so as not to drop off.

The contact-pressure spring 19 is arranged between a flange portion 21A provided at a cylindrical member 21 which is fitted along an outer periphery of the shaft 17 and the insulation member 18 supporting the movable contact 16.

The description hereinafter will focus on the vibration-absorbing member 10 for suppressing mainly the axial wobbling motions (movement in the leftward and rightward directions in FIG. 1) of the electromagnetic coil 5.

The vibration-absorbing member 10 is provided being integrated with the packing 12, and inserted into a plurality of through holes 6C formed in the disc portion 6B of the stationary core 6. Preferably, the through holes 6C may be formed along the circumference of the disc portion 6B with an even interval therebetween for the insertion of the vibration-absorbing member 10 into each of the through holes 6C.

As shown in FIG. 2A, the vibration-absorbing member 10 is adapted to be slightly longer than the thickness of the disc part 6B, or longer than the length of each through hole 6C. A tip end portion of the vibration-absorbing member 10 inserted into each through hole 6C is slightly projected (by “L” shown in FIG. 2A) from the disc part 6B toward the electromagnetic coil 5 (leftward direction in FIG. 1) and in contact with one axial end face of the bobbin 9 so as to be axially pressed against the electromagnetic coil 5.

Thus, the electromagnetic coil 5 is elastically held in the state where the other axial end face of the bobbin 9 is pressed against a bottom face 4A of the switch case 4 by the elastic force of the vibration-absorbing member 10.

Operation of the electromagnetic switch 1 will now be described.

Upon supply of current to the electromagnetic coil 5 in response to a turn-on operation of a starting switch (not shown), an electromagnet is formed to magnetize the stationary core 6, so that an attraction force is exerted between the base part 6A of the stationary core 6 and the plunger 8. As a result, the plunger 8 moves toward the base part 6A (rightward direction in FIG. 1), pushing and contracting the return spring 11. The movement of the plunger 8 pushes the shaft 17 secured to the plunger 8 to bring the movable contact 16 supported at the end portion of the shaft 17 into contact with the pair of fixed contacts 15.

Further, when the plunger 8 is moved to impart the movable contact 16 with compression loading of the contact-pressure spring 19, the movable contact 16 is pressed against the fixed contacts 15 to close the main contact, whereby electric power is supplied from the battery to the starter motor.

After starting the engine, a turn-off operation of the starting switch can stop the supply of current to the electromagnetic coil 5 to annihilate the attraction force. Thus, the plunger 8 is pushed back in a direction opposite to the base part by the reaction force of the return spring 11, by which the movable contact 16 is drawn apart from the pair of fixed contacts 15 to open the main contact. As a result, power supply to the starter motor is stopped.

Before explaining advantages of the present invention, we will explain origins of the wobbling motions of the electromagnetic coil unit 5U (including electromagnetic coil 5 and bobbin 9) relative to the other parts (i.e., switch case 4 and 4A, iron cores 6A and 6B and sleeve 7), surrounding the unit 5U, of the switch 1. The unit 5U slightly moves relative to the above-described parts surrounding the unit 5U due to slight gaps G1-G4 between the unit 5U and the parts 4, 4A, 6A, 6B and 7. The gaps G1-G4 are caused by dimensional allowances of the parts and the unit.

Of note, the starter includes the starter switch 1 and the starter motor M. The starter switch 1 is mounted on the motor M as shown in FIG. 1 and the motor M is mounted on the engine.

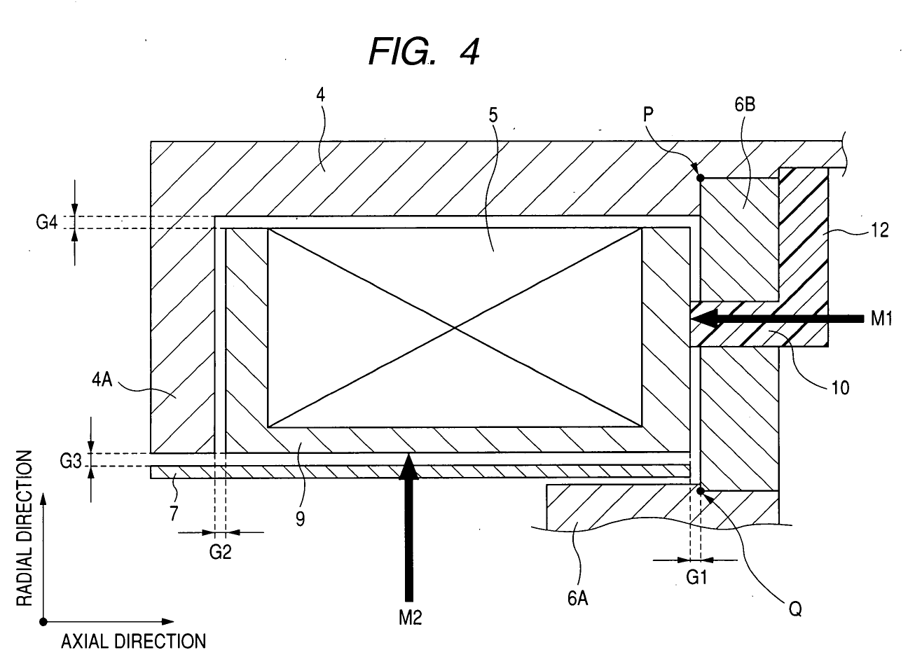

Several factors, i.e., M1 and M2 described below and shown in FIG. 4, cause the wobbling motions of the electromagnetic coil unit 5U:

M1 is mainly composed of three factors, i.e., M1A, M1B and M1C. M1A is motions transferred from the motor M through the M terminal 14 connected to the motor M via the cable D. M1B is impactive motions generated when the movable contact 16 connects to or disconnects from the fixed contacts 15. M1C is vibrations of the vehicle body via the M terminal 14 under an actual use condition.

M2 is mainly composed of two factors, i.e., M2A and M2B. M2A is vibrations of the engine (not shown) equipped with the starter switch 1 via the starter motor M. M2B is vibrations of the vehicle body via the motor M and the engine under an actual use condition

Advantages of the present invention will now be explained.

In the present embodiment, the vibration-absorbing member 10 is made of rubber. Therefore, when the electromagnetic switch 1 is exposed to a high-temperature atmosphere, the vibration-absorbing member 10 may not be deformed by creeping as in the case of a resin member, so that the elasticity for the electromagnetic coil 5 may not be lost. As a result, the function of preventing wobbling motions of the electromagnetic coil 5 can be maintained, so that wobbling motions (e.g., vibration) of the electromagnetic coil 5 may be ensured to be prevented for a long period of time.

In the electromagnetic switch 1 of the present embodiment, the vibration-absorbing member 10 for preventing wobbling motions (e.g., vibration) of the electromagnetic coil 5 is integrated into the packing 12. In other words, the packing 12 is imparted with the function of absorbing vibration of the electromagnetic coil 1. Thus, comparing with the conventional electromagnetic coil using an elastic body, such as a leaf spring, the number of components can be reduced in the electromagnetic coil of the present invention. This can lead to reducing the number of assembling processes and holding down the assembling cost. In addition, total manufacturing cost of parts may be reduced by integrally manufacturing the vibration-absorbing member 10 and the packing 12.

As described above, the vibration-absorbing member 10 is inserted into the through holes 6C formed in the disc part 6B of the stationary core 6, with its each tip end portion being slightly projected from the disc part 6B toward the electromagnetic coil 5 (leftward direction in FIG. 1) so as to be axially pressed against the electromagnetic coil 5. Advantageously, this configuration does not need to place the entire vibration-absorbing member 10 between the bobbin 9 and the disc part 6B so that the gap therebetween can be made smaller. In other words, since most part of the vibration-absorbing member 10 is inserted into the through holes 6C and since the vibration-absorbing member 10 is elastically compressed in the axial direction by being pressed against the electromagnetic coil 5, the length of the vibration-absorbing member 10 projecting from each through hole 6C can be made shorter. As a result, the electromagnetic coil 5 and the disc part 6B can be closely located in the axial direction, and thus the size of the electromagnetic switch 1 can be reduced.

In addition, the integration of the vibration-absorbing member 10 into the packing 12 may facilitate the integral molding of the packing 12 and the vibration-absorbing member 10, and may also achieve both the sealing function of the packing 12 and the vibration absorbing function of the vibration-absorbing member 10 with a single component.

(Modifications)

Various modifications can be made in the configuration of the embodiment described above as follows:

(First Modification)

The embodiment described above has been structured, as shown in FIGS. 2A and 3A, so that a part of the packing 12, which corresponds to the vibration-absorbing member 10, is inserted into the through holes 6C so as to be pressed against the electromagnetic coil unit 5U. The shape of the cross section of each through hole 6C is not limited to a circular shape but may alternatively be a rectangular shape or the like. Further, as can be seen from FIGS. 2B and 3B, notches 6C2 can be provided alternative to the through holes 6C.

(Second Modification)

As shown in FIG. 3C, the contact cover 3 may be structured so that a part 3A contacting the packing 12 has a dog bone portion 3B. This structure can further enhance the vibration-absorbing function of the electromagnetic coil 5. In the embodiment described above, a cross section of the packing 12 having the function of absorbing vibration of the electromagnetic coil 5 has had an L-shape (see FIGS. 1 and 2A) as viewed from a lateral side of the electromagnetic switch 1. The shape of the cross section of the packing 12 is not limited to the L-shape but can be other shapes, such as a T-shape, as shown in FIGS. 2C and 3C.

(Third Modification)

As shown in FIGS. 2D and 3D, the packing 12 having a function of absorbing vibration of the coil can be structured so as to be directly pressed against the electromagnetic coil 5. In this case, no interposition is needed of the disc part 6B of the stationary core 6 having the through holes 6C or the notches 6C2, but the packing 12 may be provided along the entire circumference of the outer periphery of the base part 6A of the stationary core 6.

(Fourth Modification)

In the structure of the third modification, the part 3A of the contact cover 3, which is in contact with the packing 12, may serve both as the packing 12 and the vibration-absorbing member 10 for the electromagnetic coil 5. In other words, a structure may be provided in which the part 3A of the contact cover 3, the packing 12 and the vibration-absorbing member 10 are all brought into integration (see FIG. 2E).

### Fifth Embodiment

The embodiment described above has exemplified, as a preferred embodiment, an integrated body (the sealing member) of the packing 12 and the vibration-absorbing member 10. Alternatively, the packing 12 (a sealing part of the sealing member) and the vibration-absorbing member 10 (a suppressing part of the sealing member) can be separately formed (see FIG. 2F) and further be made of different materials. In this case, although these two parts 10 and 12 can be made of rubber as is the same in the embodiment, at least one of the packing 12 and the vibration-absorbing member 10 is made of an elastic material. These structures may also maintain the vibration-absorbing function for the electromagnetic coil and may reduce the size of the electromagnetic switch as in the embodiment described above.

What is claimed is:

1. An electromagnetic switch comprising:
a solenoid comprising an electromagnetic coil unit generating an electromagnetic force by supplied an electric power thereto;
a hosing member accommodating a pair of contacts subjected to selectively connect to each other and disconnect from each other by the electromagnetic force, thereby switching on/off the switch; and
a sealing member sealing a linking portion between the solenoid and the housing and suppressing motions of the electromagnetic coil unit, the seal member having elasticity.

2. The electromagnetic switch of claim 1, the sealing member suppressing the unit from a side of the unit, the side opposing the housing.

3. The electromagnetic switch of claim 1, wherein the solenoid further comprises a plunger being moved by the electromagnetic force, the plunger having a movable contact formed thereon, the housing has a fixed contact selectively connecting to or disconnecting from the movable contact, and the pair of contacts is the fixed and movable contacts.

4. The electromagnetic switch of claim 3, further comprising a fixed iron core, the fixed iron core being provided between the housing and the solenoid, being along the sealing member and having a space penetrating therethrough, the sealing member suppressing the unit through the space.

5. The electromagnetic switch of claim 4, wherein the space is provided two or more in number.

6. The electromagnetic switch of claim 5, wherein the space are provided with an equal distance therebetween along a circumferential direction of the iron core.

7. The electromagnetic switch of claim 4, wherein the sealing member protrudes from the space to the unit.

8. The electromagnetic switch of claim 7, wherein the sealing member contacts the unit.

9. The electromagnetic switch of claim 3, wherein the sealing member is made of a high polymer material.

10. The electromagnetic switch of claim 9, wherein the high polymer material is an elastomer.

11. The electromagnetic switch of claim 9, wherein the high polymer material is a rubber.

12. The electromagnetic switch of claim 4, wherein the space is a hole provided on the iron core.

13. The electromagnetic switch of claim 4, wherein the space is a notch provided on the iron core.

14. The electromagnetic switch of claim 4, wherein the housing has a dog-born portion supporting the sealing member.

15. The electromagnetic switch of claim 1, wherein the sealing member integrally formed with the housing.

16. The electromagnetic switch of claim 1, wherein the sealing member is composed of a sealing part and a suppressing part.

17. The electromagnetic switch of claim 16, wherein the suppressing part is made of the same material of the sealing part.

18. The electromagnetic switch of claim 16, wherein at least either one of the sealing part and the suppressing part has elasticity.

19. The electromagnetic switch of claim 16, wherein the suppressing part directly contacts the sealing part.
